(19) United States
(12) Patent Application Publication
(10) Pub. No.: US 2020/0060219 A1
(43) Pub. Date: Feb. 27, 2020

(54) Combination Animal Crate with Rheostat Fan

(71) Applicants: Jon Irvin Levin, Arcadia, FL (US); Judy Victoria Levin, Arcadia, FL (US)

(72) Inventors: Jon Irvin Levin, Arcadia, FL (US); Judy Victoria Levin, Arcadia, FL (US)

(21) Appl. No.: 16/194,305

(22) Filed: Nov. 17, 2018

Related U.S. Application Data
(60) Provisional application No. 62/721,002, filed on Aug. 22, 2018.

(51) Int. Cl. A01K 1/00; A01K 1/03; A01K 1/02

(52) U.S. Cl. CPC A01K 1/0047; A01K 1/0245; A01K 1/0272; A01K 1/033

(57) ABSTRACT

Active Air Animal Crates is an appliance for the housing and transportation of dogs, and other animals, with self-contained cooling fan affixed to the crate. Active Air Animal Crates is an active ventilation animal crate made of a durable plastic. The crate can be manufactured in various sizes. The crate appliance has self-contained fans, designed for active air movement to assist in cooling that helps keep animals cooler and more comfortable in warm surroundings. The fans used are electric fans of a 115-120 AC Voltage. The fan provides white noise to decrease surrounding environmental noise and aide in calming an animal. Both side panels of the crate incorporate cut-out slots of Active Air Animal Crates trademarked logo and spiral decorative cut-outs to allow air circulation.

The present application claims the benefit of the filing date of U.S. Provisional Patent Application Ser. No. 62/721,002, filed Aug. 22, 2018, and hereby incorporated in its entirety herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND INFORMATION AND DISCUSSION OF RELATED ART

U.S. Pat. Ser. No. 62/721,002, discloses a crate which provides an enclosure that is lightweight and collapsible for travel and storage.

The above object and other objects which will become apparent upon reading the following specification and claims are achieved by a clam-shell crate having two sides, a front and a rear and a top and also including an openable front door panel, of open mesh panel construction in which the various sides.

The side themed panels contour to create a themed appearance consistent with the graphics of the side fan blade covering.

### BRIEF DESCRIPTION OF THE DRAWINGS

FIG. 1 is a forward facing view of an animal crate apparatus of this invention.

FIG. 2 is a rear-facing view of an animal crate apparatus of this invention.

FIG. 3 is a side perspective that demonstrates the use of a cut-out of a logo decorating either side of the crate, that serves as ventilation.

FIG. 4 is a perspective view of the rheostat fan with Active Air Animal Crates trademarked logo embedded on the plate covering.

FIG. 5 is a side elevation view of the cooling system illustrated in FIG. 4.

FIG. 6 is a perspective of the dog crate illustrating its specific structure.

FIG. 7 is a perspective view of a dog crate with portions broken away illustrating the orientation of the rheostat fan in relation to the dog crate illustrated in

### DETAILED DESCRIPTION OF THE INVENTION

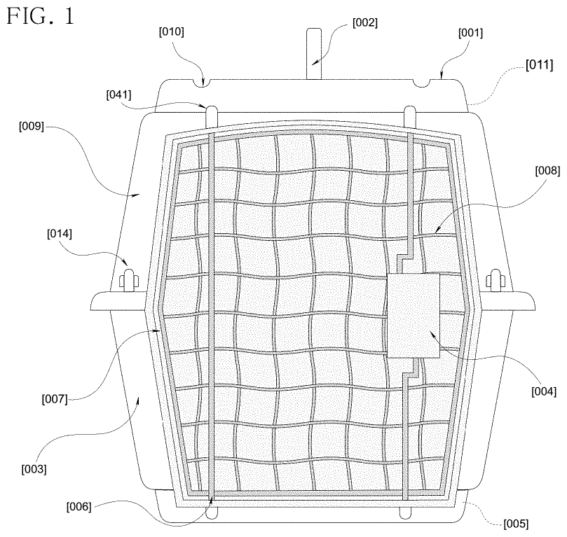

FIG. 1 is a forward facing view of an animal crate apparatus of this invention. Crate includes a travel handle for mobility 2, at the top of the crate 1. The forward facing view of the crate composes of a crate dome 11, upper front crate panel 9, crate base 5, and lower front crate panel 3. The crate front includes a door opening 7, allowing the crate door 8 to open and close. The crate door comprises of two door pins 6 that control the locking of the crate spring latch 4. These pins 6 connect into the upper and lower crate door pin housing 41 to contain an animal within the crate. The crate includes grooves 10 visible on the front facing portion of the crate for the purpose of stacking crates when they are not in use, to easily store away the top and lower components of the cage into a more compact size.

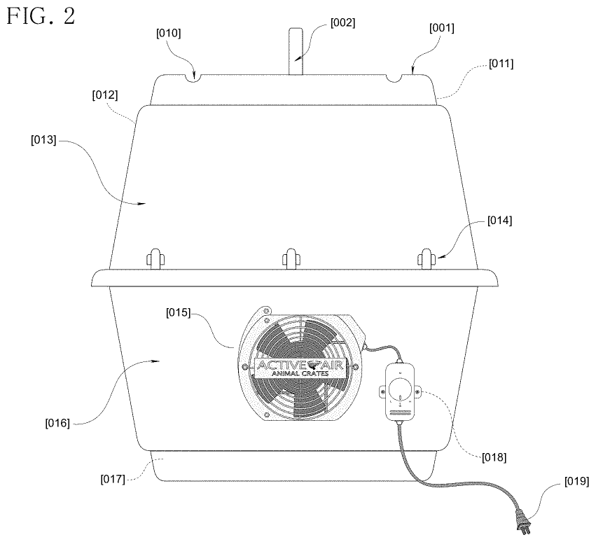

FIG. 2 is a rear-facing view of an animal crate apparatus of this invention that displays the positioning of the crate fan motor housing 15, located on the lower crate back panel 16. The mounted rheostat attachment 18 includes a cable and wall plug at its base 19. The upper crate back panel 13, comprised of an upper side panel 12 and crate top 1, and lower crate back panel 16 compose the back and lower crate base 17 secured with the use of upper and lower attachment bolt and nuts 14.

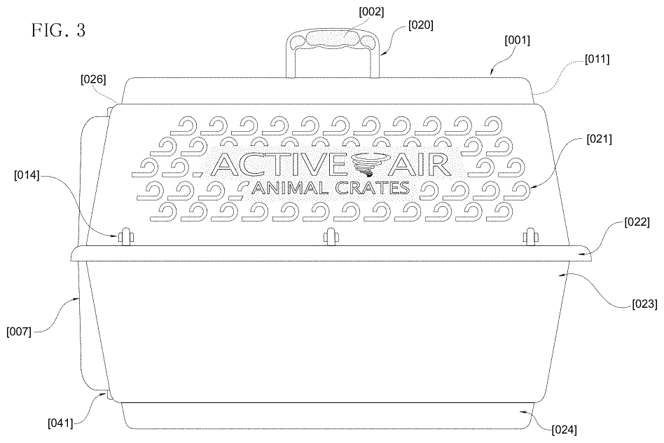

FIG. 3 is a side view of a crate apparatus upper 26 and lower side panel 23, including its upper 11 and lower dome 24. The upper side panel consists of a decorative cut out of Active Air Animal Crates Trademark logo 21 and wind spirals for air ventilation. The upper crate attachment grooves 22 locks together by three upper and lower attachment bolt and nuts 14. The perspective of the crate demonstrates a side view of the crate door 7 extending out beyond the side panels of the crate. The perspective of the crate demonstrates a side view of the crate handle 2 and the side attachment point for the crate handle 20 for the purpose of moving and relocating the crate.

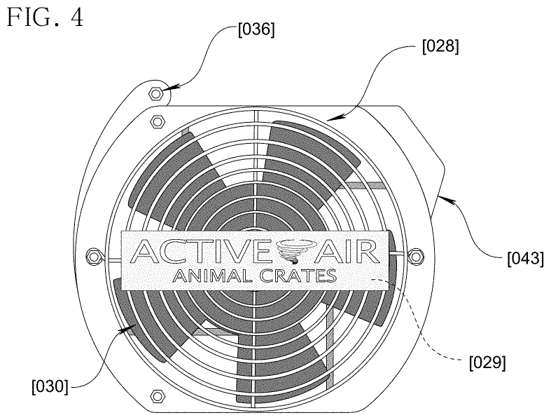

FIG. 4 is an elevation view of a rheostat fan with Active Air Animal Crates trademarked logo 29 embedded on the fan blade grate cover 28 to contain the fan blades 30. The fan housing 43 is mounted to the crate with two 2¼ inch bolt attachment sites 36.

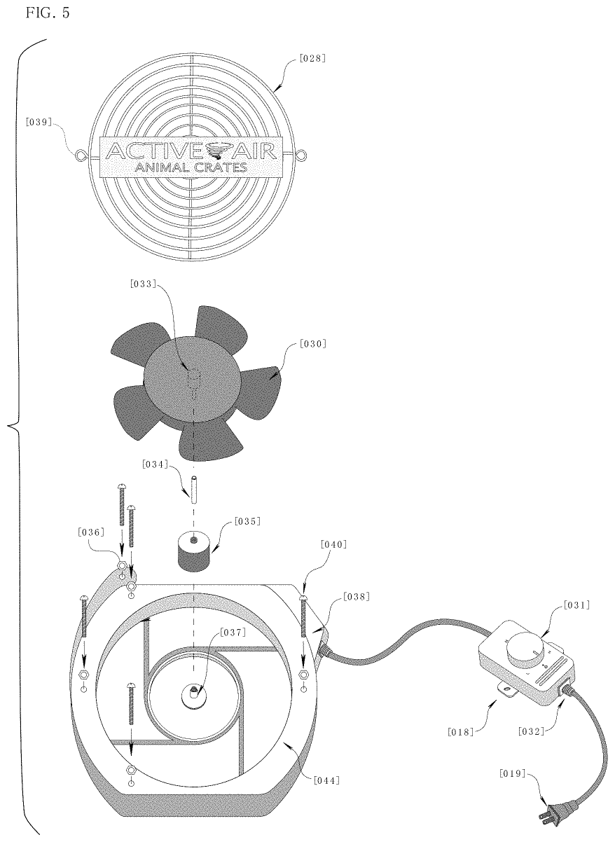

FIG. 5 is a side elevation view of the cooling system illustrated in FIG. 4 with portions broken away illustrating the orientation of the rheostat fan components. From the topmost perspective of the dog fan shown represents the fan blade cover 28 displaying the two fan blade attachment points on either side of the diameter of the fan cover 39. Descending from the fan covering shows the fan blade 30, and the respective fan shaft attachment point 33. Below the fan blade is the fan blade shaft 34 that fixes into the fan shaft brushing 35. Beyond the fan blade shaft and shaft bushing lies the fan motor that runs off of a 115-120 AC current 37. The fan motor housing 44 encases the fan motor as the fans base. Superior to the fan motor housing 44 on the upper right is the power cord attachment site 38 for the cable and wall plug 19 which delivers a 115-120 AC current 32 to the fan. Along the cable lies the rheostat power and speed adjustment 31 to control the air current delivered into the crate. Lateral to the power cord attachment site is the first bolt attachment site 36 to affix the fan housing to the crate. The fan housing and fan covering comprise of five screws 40 for secure attachment of all essential pieces.

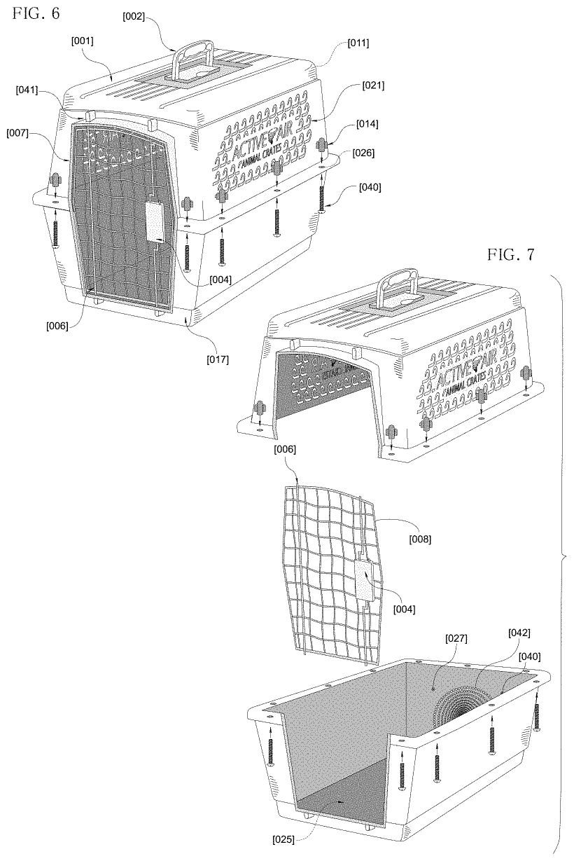

FIG. 6 is a perspective of the dog crate illustrating its specific structure.

FIG. 7 is a perspective view of a dog crate from FIG. 6, with portions broken away illustrating the orientation of the rheostat fan in relation to the dog crate base. The perspective view of the crate base and its floor 25 demonstrates the ventilation holes for fan air 42 access point and the fan attachment point 27 views from inside the base crate by the means of four screws 40.

We claim:

1. An animal crate comprising:
a crate having a fan mounted on a back wall that operates at 11SJ/120V AC, with an adjustable speed Rheostat fan of home current and inverter for power when in a vehicle.
